(19) United States
(12) Patent Application Publication
(10) Pub. No.: US 2005/0054236 A1
(43) Pub. Date: Mar. 10, 2005

(54) Cable end connector assembly having pulling device

(76) Inventors: Xian-Kui Shi, Kunsan (CN); Ming Yang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/936,252

(22) Filed: Sep. 7, 2004

(30) Foreign Application Priority Data
Sep. 5, 2003 (TW) 92124617

(51) Int. Cl. H01R 13/62

(52) U.S. Cl. 439/483

(57) ABSTRACT

A cable end connector assembly (1) includes a base (70), a number of contacts (20) received in the base, a cable (40) including a number of wires electrically connected with the contacts and a dielectric jacket (43) enclosing the wires, and a cover (60) over-molded with a connecting port (12) of the base and a front end of the cable. A pulling section (80) is integrally formed with the cover and extends along a front-to-back direction.

### BACKGROUND OF THE INVENTION

1. Field of the Invention

The present invention generally relates to a cable end connector assembly, and more particularly to a cable end connector assembly having a pulling device.

2. Description of the Prior Art

Serial ATA interface is developed with a high signal transmission speed between storage devices (such as hard disks, floppy drives, CD-ROMs, and DVDs) and a motherboard. Especially, a Serial ATA connector according to the Serial ATA standard is featured in fewer electrical contacts, higher transmission speed than other conventional Parallel ATA connectors and relatively tiny figure. Thus, it is likely that Serial ATA interface replaces Parallel ATA interface and becomes a next generation of personal computer transmission interface.

A conventional cable end connector assembly 1′ is shown in FIG. 1. The cable end connector assembly 1′ generally comprises an insulative housing 10′, a plurality of contacts (not shown) received in the housing 10′ and a cable 40′ electrically connected with the contacts. The insulative housing 10′ comprises a cover 60′ and a base 70′ over-molded with the cover 60′.

However, except the advantages stated above, the cable end connector assembly has disadvantage expressed as follow: the wires of cable are easy to separate from corresponding contacts. The reasons are described in detail hereinafter. After mating with a complementary connector (not shown) disposed on a board, A majority of the housing 10′ of the cable end connector assembly 1′ is received in the complementary connector. Because of the tiny figure of the cable end connector assembly 1′, the remained portion for being grasped is relatively small. In addition, restricted by the space of the board which has many components mounted thereon, the difficulty of pulling the cable end connector assembly 1′ from the complementary connector is increased. Thus, the user usually pulls the cable directly to separate the cable end connector assembly 1′ from the complementary connector. Since there is no any auxiliary device between the cable and the cover, most pulling force exerts on the junction between the wires and the contacts. Connection between the wires and the contacts becomes unsteady and the wires are even likely to separate from corresponding contacts.

Hence, in this art, an improved cable end connector assembly to overcome the above-mentioned disadvantage of the prior art will be described in detail in the following embodiments.

### BRIEF SUMMARY OF THE INVENTION

Accordingly, the object of the present invention is to provide a cable end connector assembly for inserting into or detaching from a complementary electrical connector more conveniently and having a good performance for resisting a pulling force exerted thereon, especially.

In order to implement the above object and overcome the above-identified deficiencies in the prior art, a cable end connector assembly in accordance with the present invention comprises an insulative housing, a plurality of electrical contacts received in the housing, a cable including a plurality of wires electrically connected with the contacts and a dielectric jacket enclosing the wires. The insulative housing comprises a base including a front mating port and an opposite connecting port and a cover over-molded with the base and the cable. Each contact comprises a contacting portion and a tail portion extending away form the contacting portion. The cover disposes a pulling section extending away from the insulative housing and integrally formed with the insulative housing.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective, assembled view of a conventional cable end connector assembly;

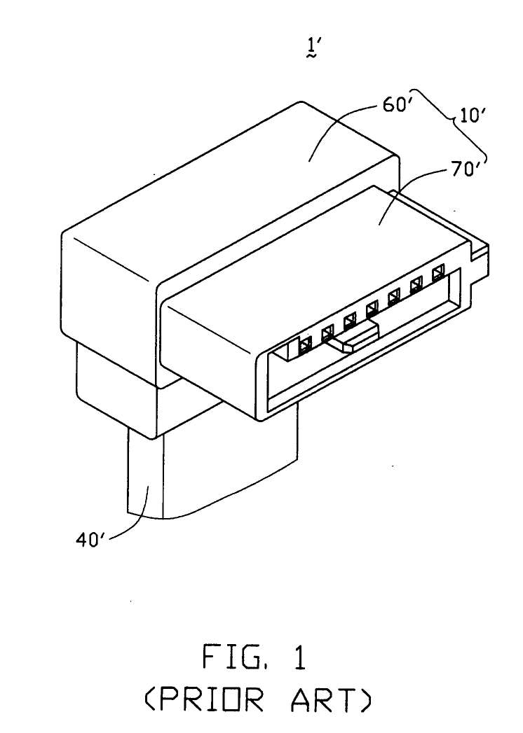

FIG. 2 is a perspective, assembled view of a cable end connector assembly in accordance with the present invention;

FIG. 3 is a view similar to FIG. 2, but taken from a different aspect;

FIG. 4 is an exploded view of the cable connector assembly shown in FIG. 3;

FIG. 5 is a partially assembled view of FIG. 4, with tail portions of contacts remaining straight;

FIG. 6 is a partially assembled view of FIG. 4, with a cover not molded;

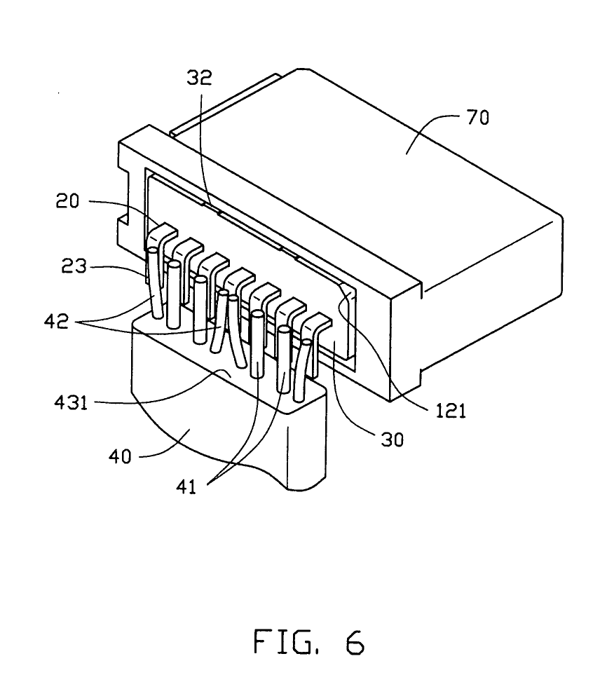

FIG. 7 is a perspective, assembled view of the cable end connector assembly in accordance with the second embodiment of the present invention; and

FIG. 8 is a view similar to FIG. 7, but taken from a different aspect;

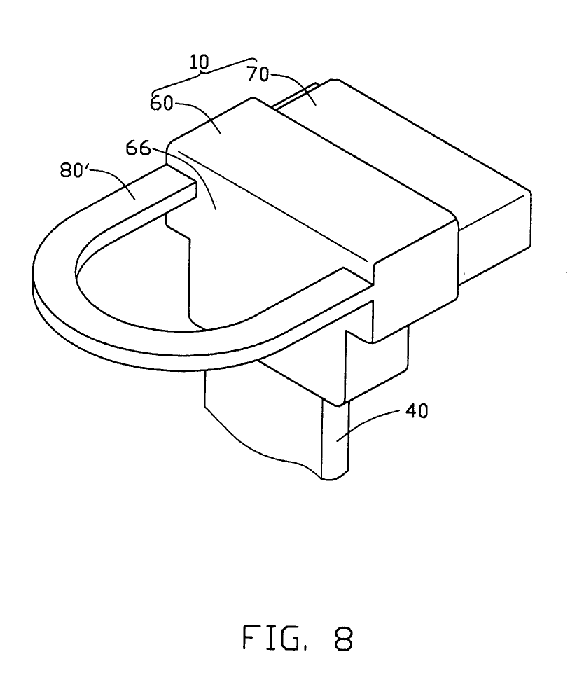

### DETAILED DESCRIPTION OF THE INVENTION

Referrence will now be made in detail to a preferred embodiment of the present invention.

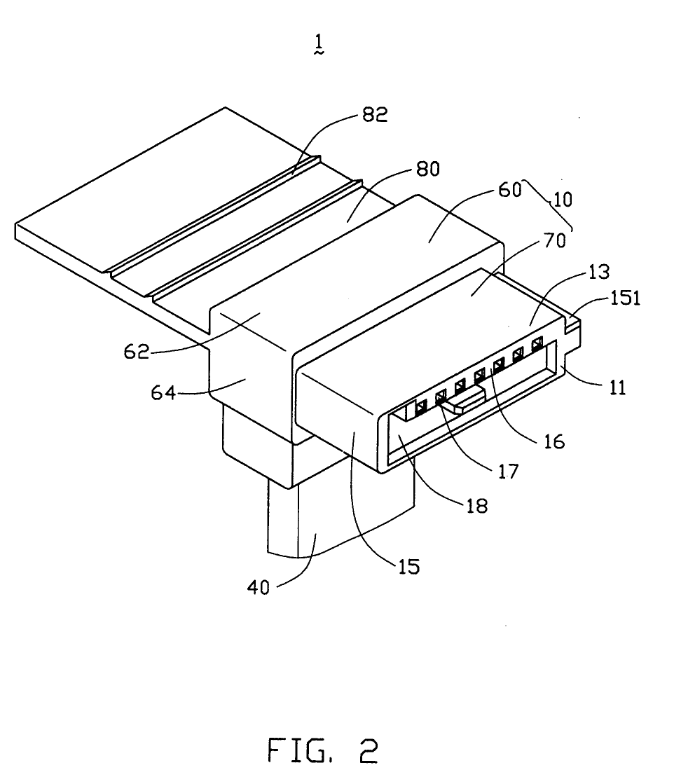

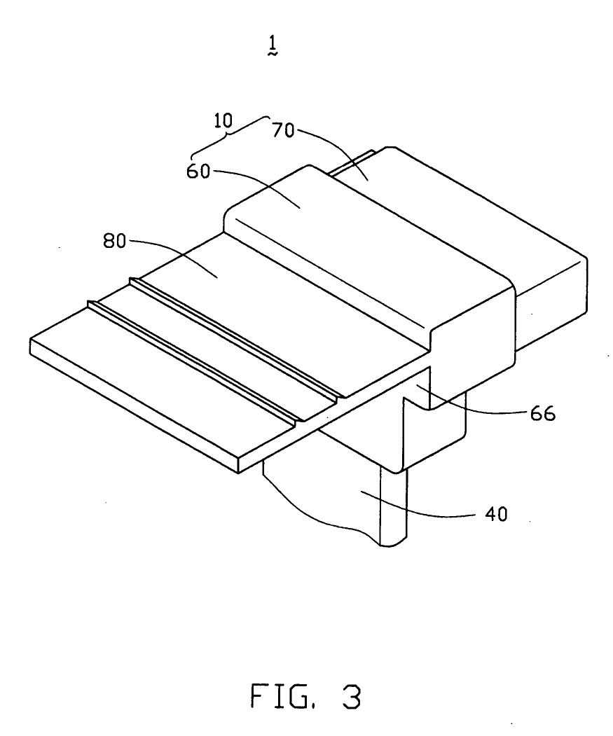

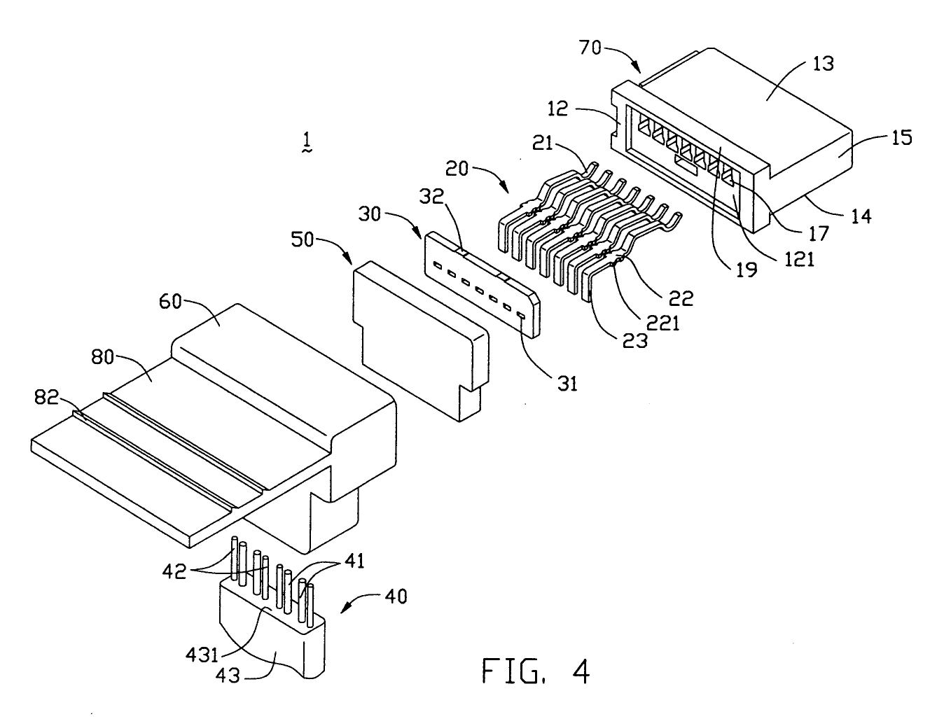

Referring to FIGS. 2-4, a cable end connector assembly 1 in accordance with the present invention comprises an insulative housing 10 including a base 70 and a cover 60 over-molded with the base 70, a plurality of electrical contacts 20 received in the base 70 in a front-to-back direction, a spacer 30 disposed in the base 70, a cable 40 electrically connected with the contacts 20 and a casing 50 enclosing the contacts 20 and the cable 40. The cover 60 encloses a connecting port 12 (shown in FIG. 4) of the base 70 and a front end of the cable 40.

The base 70 of the housing 10 comprises a mating port 11 disposed at a front thereof for engaging with a complementary connector (not shown), a connecting port 12 opposite to the mating port 11, a top wall 13, a bottom wall 14 opposite to the top wall 13 and a pair of opposite parallel lateral walls 15 connected with the top wall 13 and the bottom wall 14. The base 70 further forms a rectangular block 16 which extending from the mating port 11 towards the connecting port 12 and connected with the top wall 13 and one lateral wall 15. The block 16 defines a plurality of contact receiving slots 17 extending along said front-to-back direction. The walls 13, 14, 15 and the block 16 together define an approximately L-shaped receiving space 18 for mating with the complementary connector. A rectangular bar 151 protrudes outwardly from one of the lateral walls 15 of the base 70 for guiding a proper insertion of the complementary connector. The top wall 13 and the bottom wall 14 further form a blocking portion 19, respectively. The connecting port 12 further defines a rectangular receiving spacer 121 communicating with the contact receiving slots 17.

A plurality of electrical contacts 20 are received side by side in corresponding contact receiving slots 17. Each contact 20 comprises a contacting portion 21, a retaining portion 22 connected with the contacting portion 21, and a tail portion 23 extending from the retaining potion 22 and bending downwardly. Each retaining portion 22 defines a pluralilty of stings 221 at the two sides thereof.

The spacer 30 is a rectangular board, with a size similar to that of the receiving spacer 121. The spacer 30 defines a plurality of apertures 31. A top surface of the spacer 30 further defines a pair of protrusions 32 bearing against inner surface of the receiving spacer 121.

The cable 40 comprises wires and a dielectric jacket 43 enclosing the wires. The wires comprise two pairs of signal conductors 41 (only the signal conductors, no dielectric cover shown in Fig) for transmitting differential pair signal and four grounding conductors 42. The dielectric jacket 43 further defines a end portion 431.

The casing 50 is made of polyethylene (PE), and has a T-shaped configuration.

The cover 60 is made of polyvinyl chloride (PVC), and also has a T-shaped configuration. The cover 60 comprises an upper wall 62, a pair of side walls 64 opposite to each other and a rear wall 66 connected with the upper wall 62 and side walls 64. The cover 60 further comprises a pulling section 80 extending outwardly from the rear wall 66 of the cover 60. The pulling section 80 made of polyvinyl chloride (PVC) is integrally formed with the back wall 66 of the cover 60. The pulling section 80 has a rectangular configuration, and disposes a plurality of ribs 82 on the surface thereof. The ribs 82 increase friction between the pulling section 80 and a user when the user pulls the cable end connector assembly 1. The direction along which the pulling section 80 extending is perpendicular to the direction along which the cable 40 extending.

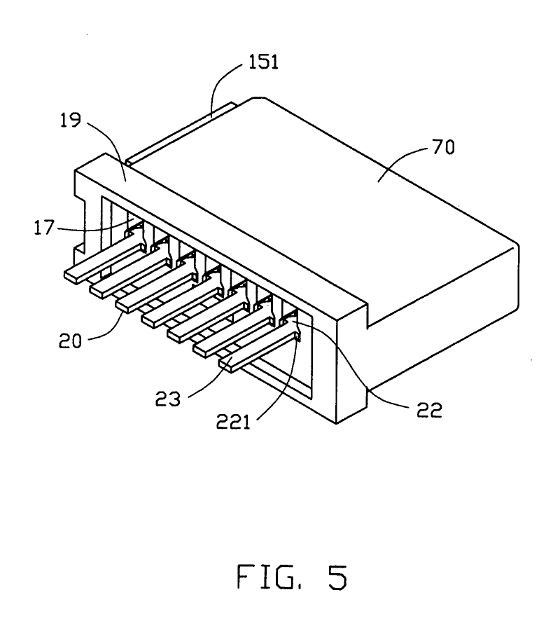

When assembled, firstly, the contacts 20 are inserted into the mating port 11 of the base 70, referring to FIG. 5. Each contact 20 is received in corresponding contact receiving slot 17. The retaining portions 22 of the contacts 20 are interferentially engaged with the lateral sides (not labelled) of the contact receiving slots 17 by the stings 221. The tail portions 23 of the contacts 20 extend beyond the contact receiving slots 17. Secondly, the spacer 30 is asssembled to the base 70. The spacer 30 is received in the receiving spacer 121, with the protrusions 32 of the spacer 30 abutting against the inner surface of the receiving spacer 121 so as to fix the spacer 30 in the receiving spacer 121. The tail portions 23 of the contacts 20 protrude through the apertures 31 of the spacer 30 and bend downwardly. The spacer 30 is able to prevent the PE or PVC produced in the process of over-molding the casing 50 and the cover 60 from flowing into the contact receiving slots 17 of the base 70. Next, soldering the contacts 20 with the cable 40. Then, putting the connecting port 12 of the base 70 and the front end of the cable 40 into a die (not shown) to over-mold the casing 50, the casing 50 encloses the connecting port 12 and the front end of the cable 40 to reinforce the connection. Lastly, over-molding the cover 60 and the pulling section 80. The PVC encloses the connecting port 12 of the base 70, the casing 50 and the end portion 431 of the dielectric jacket 43. The cover 60 integrates interferentially with the blocking portion 19 of the base 70 and the casing 50 after being cooled.

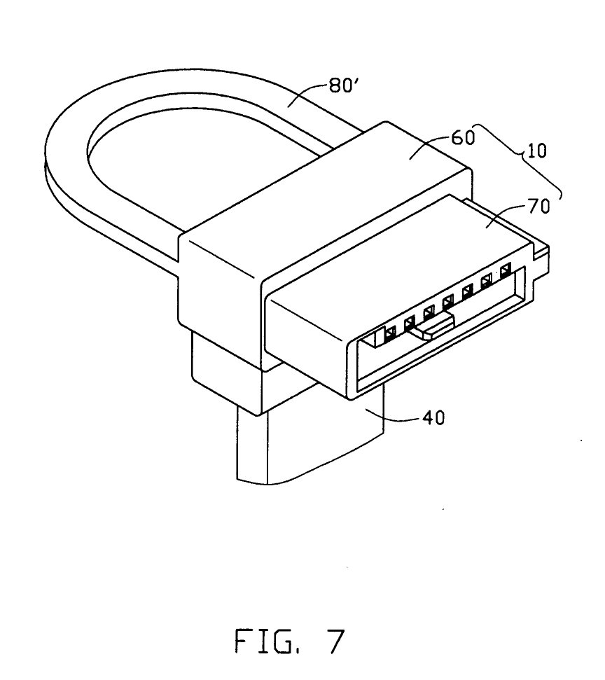

The pulling section 80 of the cable end connector assembly 1 in according with above embodiment has a rectangular configuration. Referring to FIG. 7, the pulling section 80′ also can have an U-shaped and hollow configuration, this configuration makes a user convenient to pull the cable end connector assembly out from the complementary connector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cable end connector assembly, comprising:
a base comprising a mating port and a connecting port opposite to the mating port;
a plurality of contacts received in the base;
a cable comprising a plurality of wires electrically connected with corresponding contacts; and
a cover defining a pulling section integrally formed with the cover and extending therefrom.

2. The cable end connector assembly as claimed in claim 1, wherein the direction along which the pulling section extending is away from the base and perpendicular to the direction along which the cable extending.

3. The cable end connector assembly as claimed in claim 1, wherein the upper surface of the pulling section forms a plurality of ribs for increasing friction.

4. The cable end connector assembly as claimed in claim 1, wherein the pulling section has a rectangular figure.

5. The cable end connector assembly as claimed in claim 1, wherein the pulling section has an U-shaped figure.

6. The cable end connector assembly as claimed in claim 1, wherein the cable end connector assembly further comprises a casing enclosing the tail portions of the contacts and the wires of the cable.

7. The cable end connector assembly as claimed in claim 1, wherein the base comprises a receiving space having a L-shaped configuration for mating with a complementary connector.

8. The cable end connector assembly as claimed in claim 1, wherein the cable further comprises a dielectric jacket enclosing the wires.

9. A cable end connector assembly, comprising:
an insulative housing comprising a mating port and an opposite connecting port;
a plurality of contacts received in the insulative housing;
a cable comprising a plurality of wires electrically connected with the contacts; and
a pulling section integrally formed with the insulative housing and extending therefrom.

10. The cable end connector assembly as claimed in claim 9, wherein the cable further comprises a dielectric jacket enclosing the wires.

11. The cable end connector assembly as claimed in claim 9, wherein the pulling section disposes a plurality of ribs providing friction for pulling.

12. The cable end connector assembly as claimed in claim 9, wherein each contact comprises a contacting portion and a tail portion extending from the contacting portion.

13. The cable end connector assembly as claimed in claim 9, wherein the cable end connector assembly further comprises a casing enclosing the tail portions of the contacts and the wires of the cable.

14. A method of making a cable end connector, comprising steps of:
providing an insulative housing with a plurality of contacts therein;
equipping said housing with a front mating portion defining a mating direction, and a rear connection portion;
assembling a cable unit to said rear connection portion with a non-parallel relation with regard to said mating direction; and
applying an insulative cover to at least both the rear connection portion of said housing and a front portion of the cable unit via an overmolding process; wherein said cover includes integrally a pulling section extending essentially being coplanar with said mating portion and along a direction parallel to said mating direction.
